(19) United States
(12) Patent Application Publication
(10) Pub. No.: US 2015/0134846 A1
(43) Pub. Date: May 14, 2015

(54) METHOD AND APPARATUS FOR MEDIA SEGMENT REQUEST RETRY CONTROL

(71) Applicant: QUALCOMM Incorporated, San Diego, CA (US)

(72) Inventors: Satish Bazar, Hyderabad (IN); Praveen Kota, San Diego, CA (US); Giridhar Kapalli, Hyderabad (IN)

(73) Assignee: QUALCOMM Incorporated, San Diego, CA (US)

(21) Appl. No.: 14/080,221

(22) Filed: Nov. 14, 2013

(51) Int. Cl. H04L 29/06

(52) U.S. Cl. CPC H04L 65/60
USPC 709/231

(57) ABSTRACT

Methods and apparatus for media segment request retry control are disclosed. Embodiments implement one or more media segment retry back off interval calculated as a function of an aspect of a client media segments play-out buffer, wherein the media segment retry back off interval defines a period before a subsequent retry for a media segment is attempted. The retry back off interval may be calculated as a function of a depletion rate of content from the client media segments play-out buffer, a function of a change in size of the client media segments play-out buffer, or a combination thereof according to embodiments. Embodiments may implement a media segment retry termination point as a function of an estimated media segment transaction time and a next media segment availability time.

### DESCRIPTION OF THE RELATED ART

With the proliferation of various configurations of user equipment having advanced communication and processing capabilities continues to grow, so does the availability of and demand for content accessed using such user equipment. For example, as the functionality of user equipment, such as smart phones, personal digital assistants (PDAs), tablet devices, etc., has become more robust the ability to stream various forms of media, such as audio, video, multimedia, etc., has become both more widely supported and commonly used. The streaming of such media may comprise streaming selected previously recorded media files to enable an “on demand” media experience for users. Moreover, the media streamed may comprise live streaming media, such as audio and/or video of a live event, to provide a real-time media experience for users.

Live streaming technologies typically operate to break the content into segments which are made available to clients, such as the aforementioned user equipment, according to a strict timeline (e.g., media segment availability time and media segment expiration time) which may be published to the clients for use in accessing the content. For example, in live HTTP adaptive streaming technologies the multimedia content is broken in to small segments which are time bounded. The availability of media segments on the HTTP server at the indicated time is a result of live encoders encoding the live content, one or more segmenter creating the segments, and these media segments arriving at the HTTP server for client access. Delays involved in one or more of the steps of this process may result in a media segment not being available for consumption in time for the adaptive streaming client. That is, because of the live streaming environment there may be transport and/or processing delays rendering one or more segment unavailable at its designated time.

Live streaming clients available today may resolve the issue of unavailable segments by simply skipping that segment and moving on to request a next segment in the stream (e.g. by using an HTTP GET to request the next segment). Such a solution, although being bandwidth efficient, often results in a diminished user experience due to the jumping or skipping of content portions being readily perceivable to the user.

Another way in which live streaming clients available today may resolve the issue of unavailable segments is to implement a blind retry request methodology. For example, upon receiving notification of segment unavailability (e.g., receiving a “404 file not found” HTTP response) the client may proceed to issue a predetermined number of retry requests. Such blind retries may result in accessing the previously unavailable segment after it does become available. However, this technique suffers from disadvantages associated with the undesired and/or inefficient consumption of bandwidth associated with a number of blind retries and delaying access to subsequent segments due to blindly issuing a predetermined number of retry attempts.

### SUMMARY

An embodiment of a method of media content communication comprises determining that a media segment is not available from a streaming media server, and calculating a media segment retry back off interval as a function of an aspect of a client media segments play-out buffer, wherein the media segment retry back off interval defines a period before the client retries requesting the media segment from the streaming media server.

An embodiment of a computer program product for wireless communications in a wireless network comprises a computer-readable medium having program code recorded thereon. The program code comprises program code to determine that a media segment is not available from a streaming media server, and program code to calculate a media segment retry back off interval as a function of an aspect of a client media segments play-out buffer, wherein the media segment retry back off interval defines a period before the client retries requesting the media segment from the streaming media server.

An embodiment of an apparatus configured for wireless communication comprises at least one processor, and a memory coupled to said at least one processor. The at least one processor is configured to determine that a media segment is not available from a streaming media server, and to calculate a media segment retry back off interval as a function of an aspect of a client media segments play-out buffer, wherein the media segment retry back off interval defines a period before the client retries requesting the media segment from the streaming media server.

### BRIEF DESCRIPTION OF THE DRAWINGS

In the figures, like reference numerals refer to like parts throughout the various views unless otherwise indicated. Letter character designations for reference numerals may be omitted when it is intended that a reference numeral encompass all parts having the same reference numeral in all figures.

FIG. 1 is a functional block diagram of an embodiment of an apparatus for media segment requesting retry control.

FIG. 2 is a flowchart of an embodiment of a method for media segment requesting retry control.

FIGS. 3A and 3B are ladder diagrams showing operation of media segment requesting retry control according to embodiments.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the term “content” may include data having video, audio, combinations of video and audio, or other data at one or more quality levels, the quality level determined by bit rate, resolution, or other factors. The content may also include executable content, such as: object code, scripts, byte code, markup language files, and patches. In addition, “content” may also include files that are not executable in nature, such as documents that may need to be opened or other data files that need to be accessed.

As used in this description, the term “media segment” refers to one or more portions of content that may be received at a user device.

As used in this description, the term “streaming content” refers to content that may be sent from a server device and received at a user device according to one or more standards that enable the real-time transfer of content. Examples of streaming content standards include those that support de-interleaved (or multiple) channels and those that do not support de-interleaved (or multiple) channels.

As used in this description, the term “content identifier” refers to one or more lists, manifests, configuration files, or other identifiers that may identify the content or that may identify one or more content segment.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

As used herein, the terms “user equipment,” “user device,” and “client device” include devices capable of requesting and receiving content from a web server and transmitting information to a web server. Such devices can be a stationary devices or mobile devices. The terms “user equipment,” “user device,” and “client device” can be used interchangeably.

As used herein, the term “user” refers to an individual receiving content on a user device or on a client device and transmitting information to a website.

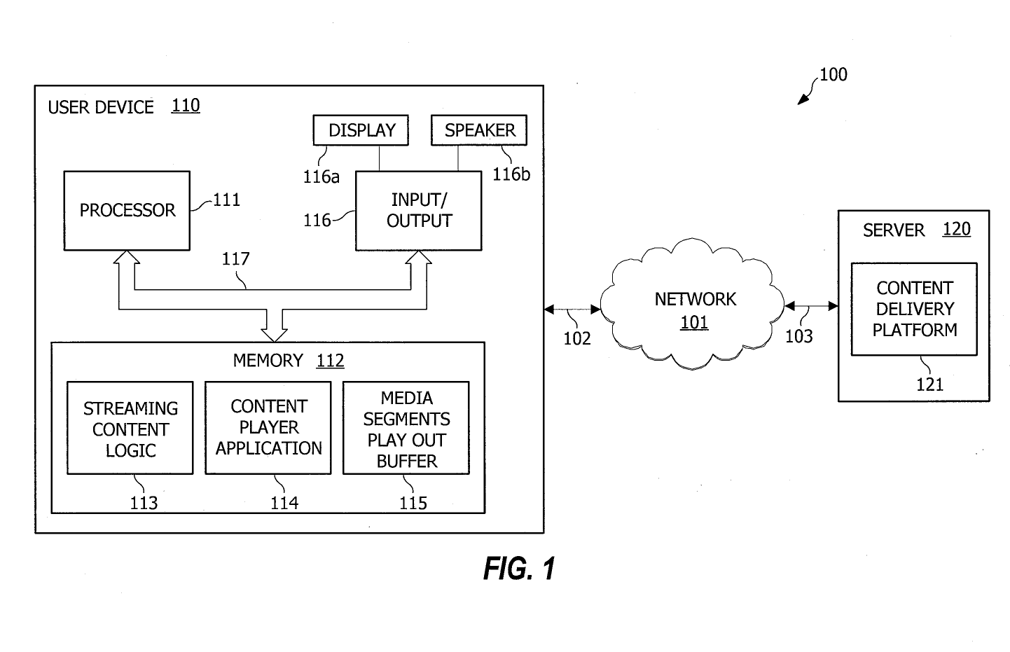

FIG. 1 is a functional block diagram of an embodiment of an apparatus for media segment request retry control. Apparatus 100 of the illustrated embodiment comprises user device 110, network 101, and server 120. User device 110 can be connected to network 101 over a bi-directional connection, such as is represented by network connection 102. The connection can be a wired connection or can be a wireless connection. In an embodiment, connection 102 can be a wireless connection, such as a cellular 4G connection, a wireless fidelity (WiFi) connection, a Bluetooth connection, or another wireless connection. Server 120 can be connected to network 101 over a bi-directional connection , such as represented by network connection 103. The connection can be a wired connection or can be a wireless connection. Network 101 can be a wireless network, a wired network, a wide area network (WAN), a local area network (LAN), or any other network. In an embodiment, network 101 can comprise at least portions of the Internet.

Server 120 can be any server that can deliver streaming content to user device 110. In one non-limiting example, server 120 can be a web server configured as a hypertext transfer protocol (HTTP) web server and can include a content delivery platform 121. Content delivery platform 121 can be any system or methodology that can deliver content to the user device 110.

User device 110 can comprise a wired device, a wireless device, a personal computing device, a tablet or pad computing device, a portable cellular telephone, a WiFi enabled device, a Bluetooth enabled device, a television, a pair of glasses having a display, a pair of augmented reality glasses, or any other communication, computing or interface device connected to network 101 and can communicate with server 120 using any available methodology or infrastructure. User device 110 can also be referred to as a “client device” because it can function as, or be connected to, a device that functions as a client of server 120.

User device 110 of the illustrated embodiment comprises a plurality of functional blocks, shown here as including processor 111, memory 112, and input/output (I/O) element 116. Although not shown in the representation in FIG. 1 for simplicity, user device 110 may comprise additional functional blocks, such as a user interface, a radio frequency (RF) module, a camera, a sensor array, a display, a video player, a browser , etc., some or all of which may be utilized by operation in accordance with the concepts herein. The foregoing functional blocks may be operatively connected over one or more bus, such as bus 117. Bus 117 may comprises the logical and physical connections to allow the connected elements, modules, and components to communicate and interoperate.

Memory 112 can be any type of volatile or non-volatile memory, and in an embodiment, can include flash memory. Memory 112 can be permanently installed in user device 110, or can be a removable memory element, such as a removable memory card. Although shown as a single element, memory 112 may comprise multiple discrete memories and/or memory types.

Memory 112 may store or otherwise include various computer readable code segments, such as may form applications, operating systems, files, electronic documents, content, etc. For example, memory 112 of the illustrated embodiment comprises streaming content logic 113 and content player application 114. Streaming content logic 113 can be software, firmware, a combination of software and firmware, or any code that allows user device 110 to request and receive streaming content from server 120. Content player application 114 can be any module that renders content on an interface of device 110, such as display 116a and/or speakers 116b of or coupled to I/O element 116 for presenting content for viewing and/or listening by a user of the device. Content player application 114 may interoperate with one or more other functional block, such as a rendering application, a browser, etc., to provide content playback. Content player application 114 and streaming content logic 113 may cooperate to operate as an adaptive streaming client, whereby the bandwidth of the links between user device 110 and server 120 and/or the processor capacity of user device 110 and/or server 120 are monitored in real time and the quality of a media stream are dynamically adjusted accordingly.

The code segments stored by memory 112 may provide applications in addition to the aforementioned streaming content logic 113 and content player application 114. For example, memory 112 may store applications such as a browser, useful in accessing content from server 120 according to embodiments herein. Such a browser can be a web browser, such as a hypertext transfer protocol (HTTP) web browser for accessing and viewing web content and for communicating via HTTP with the server 120 over connections 102 and 103, via network 101, if the server 120 is a web server. As an example, an HTTP request can be sent from the browser in user device 110, over connections 102 and 103, via network 101, to server 120. An HTTP response can be sent from server 120, over connections 103 and 102, via network 101, to the browser in user device 110.

In addition to the aforementioned code segments forming applications, operating systems, files, electronic documents, content, etc., memory 112 may include or otherwise provide various registers, buffers, and storage cells used by functional block so user device 110. For example, memory 112 of the illustrated embodiment comprises media segments play-out buffer 115. Media segments play-out buffer 115 provides a first-in/first-out (FIFO) memory for spooling data of media segments for real-time streaming from server 120 and playback by user device 110.

Processor 111 can be any general purpose or special purpose processor capable of executing instructions to control the operation and functionality of user device 110. Although shown as a single element, processor 111 may comprise multiple processors, or a distributed processing architecture.

I/O element 116 can include and/or be coupled to various input/output components in addition to or in the alternative to the aforementioned display 116a and speakers 116b. For example, I/O element 116 may include and/or be coupled to a microphone, a keypad, a pointing device, a touch-sensitive screen, user interface control elements, and any other devices or systems that allow a user to provide input commands and receive outputs from user device 110. Any or all such components may be utilized to provide a user interface of user device 110.

In operation to access and play streaming content, user device 110 communicates with server 120 via network 101, using links 102 and 103, to obtain the media segments which, when rendered, provide playback of the content. Accordingly, content player application 114 may be executed by processor 111 to establish a content playback environment in user device 110. Streaming content logic 113 may interact with content player application 114 to coordinate requesting media segments from content delivery platform 121 of server 120 and to control their downloading to media segments play-out buffer 115 for rendering, in turn, by content player application 114. When initiating playback of a particular content file, content player application 114 may communicate with content delivery platform 121 of server 120 to obtain a content identifier (e.g., one or more lists, manifests, configuration files, or other identifiers that identify the media segments, and their timing boundaries, of the desired content). The information regarding the media segments and their timing is used by streaming content logic 113 to control requesting the media segments for playback by content player application 114.

It should be appreciated, however, that media segments may not always be available from content delivery platform 121 at a media segment's availability time designated in the content identifier. For example, delays involved in one or more of the steps of the process of originally communicating the content to server 120, segmenting the content, encoding the content segments, etc., particularly in a live streaming situation, may result in a media segment not being available to streaming content logic 113 at the designated time. Accordingly, embodiments of the present disclosure implement media segment request retry control in order to efficiently and effectively request media segments previously determined to have been unavailable from content delivery platform 121.

In operation according to embodiments, streaming content logic 113 operates to determine that a media segment is not available from content delivery platform 121 and then for one or more attempts retries requesting the media segment from the server, which may be an initial media segment or a subsequent media segment. However, there is a non-zero cost associated with each retry (e.g. associated with the use of network resources). Accordingly, embodiments operate to control the number of retry attempts by dynamically computing a retry back off interval and/or retry termination point for requesting any particular media segment. Such control with respect to the retries may be based on the current media segment duration, buffer attributes, and/or availability timing of the next media segment.

The retries may be provided in uniform or non-uniform implementations according to embodiments. In a uniform retry implementation, streaming content logic 113 may attempt multiple retries to request the media segment with each retry attempt timed at equal intervals throughout a media segment availability window (e.g., Media Segment Availability Window=Media Segment Availability time in Milliseconds+Media Segment Duration in Milliseconds). In a non-uniform retry implementation, a media segment availability window may be divided into multiple portions (e.g., at least some of which are unequal) and streaming content logic 113 can attempt retries differently with respect to the media segment availability window portions.

The periods or back off intervals (referred to herein as retry back off interval) between multiple retries of either uniform or non-uniform retry embodiments may be determined based upon a number of factors. For example, embodiments may utilize a base retry back off interval determined from equal intervals which provide a desired number of retries throughout a media segment availability window. An example of such base retry back off intervals are shown in the table below.

| | Retry Back Off Interval | |
|---|---|---|
| Media | Time between consecutive | |
| Segment | retries in the media segment | Total number of retries |
| Duration | availability window in | attempted in the media |
| in Secs | MilliSecs | segment availability window |
| 1 | 100 | 10 |
| 2 | 100 | 20 |

Additionally or alternatively, the retry back off intervals between multiple retries may be determined as a function of attributes of a media segments play-out buffer used for buffering the media segments for playback (e.g., media segments play-out buffer 115). For example, a period between retries (e.g., the base retry back off interval) may be increased based on an increase in media segments play-out buffer size and/or a decrease in media segments play-out buffer depletion rate, whereas the period between retries may be decreased based on a decrease in media segments play-out buffer size and/or an increase in media segments play-out buffer depletion rate. Accordingly, streaming content logic 113 of may operates to monitor and analyze media segments play-out buffer 115 to determine play-out buffer size and/or rate of change (e.g., depletion rate/growth rate). This information may be analyzed, such as through comparison to predetermined threshold information in determining the retry back off interval (e.g., whether to increase or decrease a base retry back off interval at an particular time in the streaming media session). For example, streaming content logic 113 may operate (1) to compare a media segments play-out buffer size to a media segments play-out buffer upper size threshold to determine that the retry back off interval is to be increased; (2) to compare a media segments play-out buffer size to media segments play-out buffer lower size threshold to determine that the retry back off interval is to be decreased; (3) to compare a media segments play-out buffer rate of change to a rate of change increase threshold to determine that the retry back off interval is to be increased; (4) to compare a media segments play-out buffer rate of change to a rate of change decrease threshold to determine that the retry back off interval is to be decreased; or any combination thereof.

In implementing non-uniform retry back off intervals according to embodiments, a different number of retries to request the media segment may be provided during one portion of the media segment availability window as compared to during another portion of the media segment availability window (e.g., to provide more retries in an earlier portion of the media segment availability window). In such a non-uniform retry implementation, the client may be provided a greater chance of receiving the media segment sooner, such as when the segment availability delay is significantly small in comparison with the media segment duration. The following table provides illustrative examples of non-uniform retry back off intervals wherein the number of retires made in a first portion (e.g., the first half) and second portion (e.g., the second half) of the media segment availability window differ.

| | | | Retry Back | | Retry Back | | |
|---|---|---|---|---|---|---|---|
| | | | Off Interval | Number of | Off Interval | Number of | |
| | | | in First | Retries in | in Second | Retries in | |
| | | | Portion of | First | Portion of | Second | |
| | | Media | Media | Portion of | Media | Portion of | |
| Media | | Segment | Segment | Media | Segment | Media | |
| Segment | Transaction | Availability | Availability | Segment | Availability | Segment | |
| Duration | Time | Window in | Window | Availability | Window | Availability | Total |
| (Secs) | (Msecs) | Msecs | (Msecs) | Window | (Msecs) | Window | Retries |
| 1 | 100 | 900 | 100 | 4 | 200 | 2 | 6 |
| 2 | 150 | 1900 | 100 | 9 | 200 | 4 | 13 |
| 3 | 200 | 2800 | 100 | 14 | 200 | 7 | 21 |
| 4 | 300 | 3700 | 100 | 18 | 200 | 9 | 27 |
| 5 | 400 | 4500 | 100 | 22 | 200 | 11 | 33 |

It should be appreciated that in the examples provided in the table above, streaming content logic 113 is more aggressive in retries in the first portion of the media segment availability window than in the second portion. Such an implementation may be advantageous for maintaining a high level of user satisfaction because if the media segment is obtained earlier (e.g., in the first portion of the media segment availability window) the user typically would not perceive a degradation in the playback quality (e.g., pause or stutter in playback) because the media segment is likely to be obtained and available for content player application 114 before the previous media segment is drained from media segments play-out buffer 115. Accordingly, such non-uniform retry back off interval implementations provide a balance between maintaining a high quality user experience while mitigating impact upon bandwidth utilization associated with media segment retry.

The particular values for the retry back off intervals set forth in the examples of the table above may incorporate or be adjusted to incorporate the aforementioned increases/decreases as a function of attributes of a media segments play-out buffer. For example, the retry back off intervals in either or both the first and second portions of the media segment availability window may be increased based on an increase in media segments play-out buffer size and/or a decrease in media segments play-out buffer depletion rate. Likewise, the retry back off intervals in either or both the first and second portions of the media segment availability window may be decreased based on a decrease in media segments play-out buffer size and/or an increase in media segments play-out buffer depletion rate. Media segments play-out buffer and/or media segment metrics, such as time to play (e.g., time to play a current or next media segment) or time to play-out (e.g., time to exhaustion of the media segments play-out buffer), may be used by streaming content logic 113 in determining how aggressive to be in a given availability window, or portion thereof, with respect to the retry back off intervals. For example, if a time to play value of a media segment being retried is relatively low, then more retries may be attempted (i.e., more aggressive retrying for the media segment). However, if the time to play value of a media segment being retries is relatively high, then less retries may be attempted (i.e., less aggressive retrying for the media segment).

Streaming content logic 113 may operate to retry for any particular media segment (e.g., using either a uniform retry or non-uniform retry implementation) until the earlier of a media segment availability event (e.g., the receipt of the previously unavailable media segment or the availability of a next media segment) and/or a media segment retry termination point (e.g., the cutoff point beyond which the client does not attempt another retry).

A media segment retry termination point may be determined based upon an estimated transaction time (TT) for the media segment download and playback (e.g., transaction time=round trip time for requesting a media segment through completion of download of the requested media segment to the client). The TT for downloading a media segment can be estimated as, and can be smoothened using, a moving weighted average to get an average estimated TT (TT_{avg}). Streaming content logic 113 may operate to stop retrying for a particular media segment if the time of request+TT of the media segment overlaps with the next media segment's availability time (e.g., client stops retrying if the following condition is met: Current Time+TT_{avg}>=Next Segment Availability Time, or stated differently Media Segment Retry Termination Point>=Next Segment Availability Time−Transaction Time).

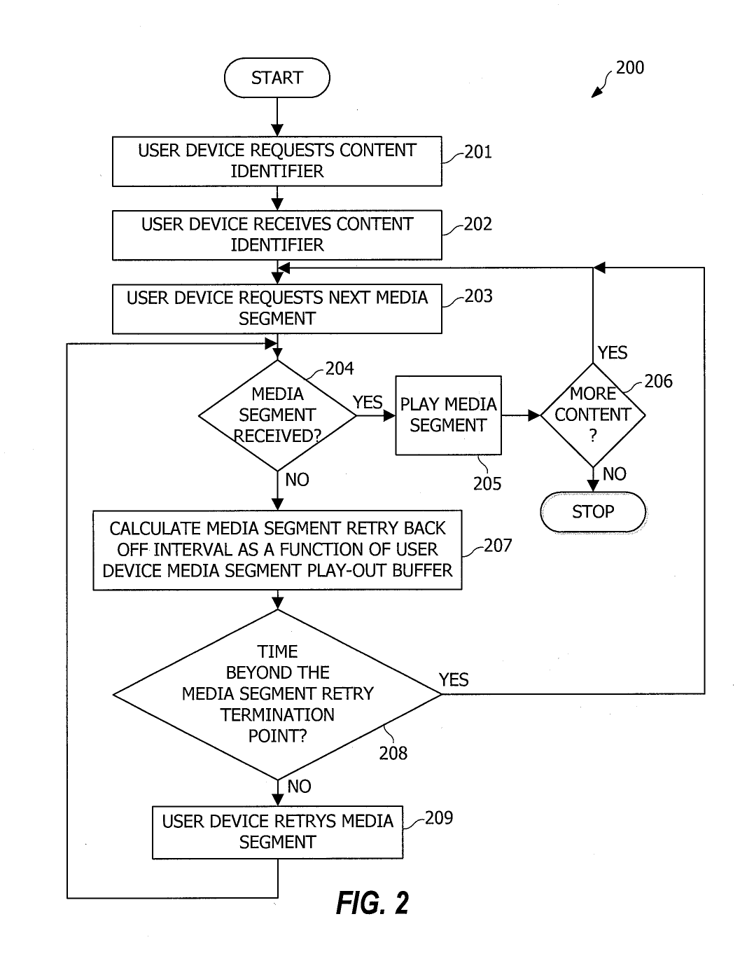

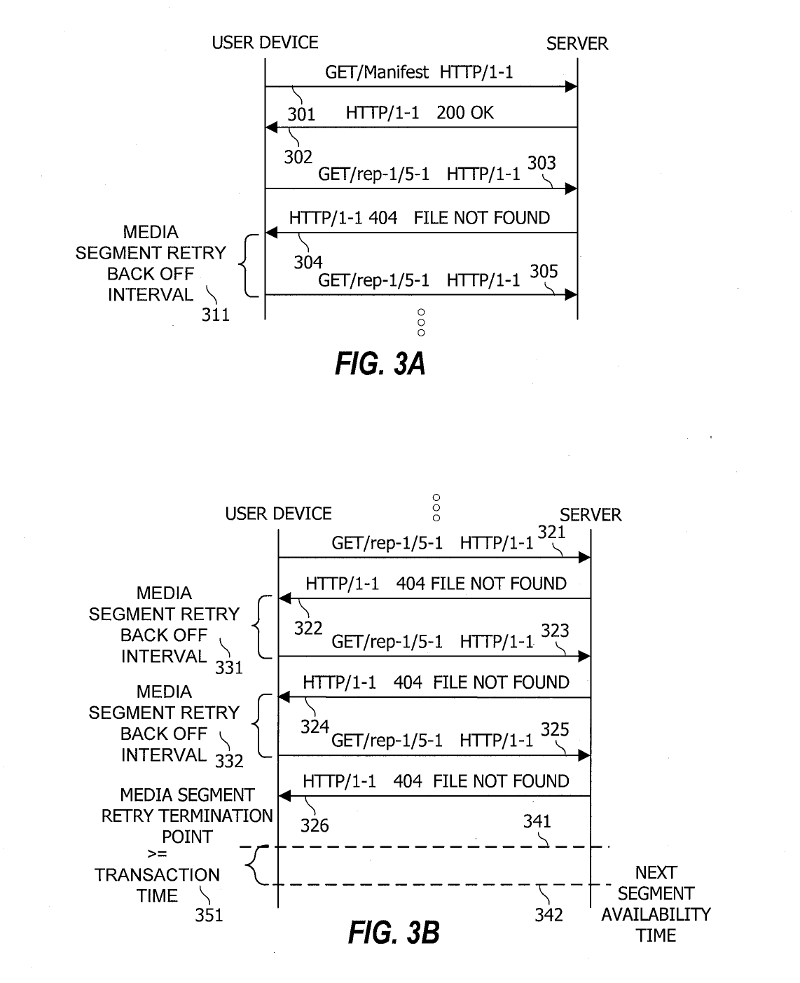

FIG. 2 shows a flowchart of an embodiment of an operation of apparatus 100 providing media segment request retry control according to the concepts herein. Flow 200 of the illustrated embodiment begins at block 201 wherein user device 110 requests a content identifier from content delivery platform 121. For example, a user of user device 110 may interact with content player application 114 and/or a host application (e.g., a browser executing on user device 110) to select content for playback (e.g., live streaming content, such as of a sporting event, news cast, political presentation, etc.). To initiate playback of the selected content, content player application 114 may interact with streaming content logic 113 to obtain the content identifier corresponding to the selected content from content delivery platform 121 in order to facilitate playback of the content. This operation is illustrated by request 301 shown in FIG. 3A.

At block 202 user device 110 receives the appropriate content identifier from content delivery platform 121. This operation is illustrated by response 302, issued in response to request 301, shown in FIG. 3A. The content identifier may be stored in memory 112 whereby streaming content logic 113 may utilize the content identifier's information regarding media segments and time bound information for the selected content to control requesting media segments and implementing media segment request retry control according to the concepts herein.

At block 203 user device 110 requests the next media segment for payback. For example, streaming content logic 113 may utilize the content identifier information to identify the next media segment and request that media segment from content delivery platform 121 (e.g. by using an HTTP GET to request that media segment). This operation is illustrated by request 303 shown in FIG. 3A.

A determination is made at block 204 to whether the requested media segment has been received by user device 110. If the requested media segment has been received by user device 110, the media segment may be placed in media segments play-out buffer 115, which content player application 114 may use to play the media segment at block 205. Thereafter, a determination may be made as to whether there are more media segments for the selected content remaining to be played at block 206. For example, streaming content logic 113 may utilize the content identifier information to determine if the received media segment was the last media segment for the selected content, whereby processing according to flow 200 of the illustrated embodiment stops if so, or otherwise returns to block 203 to request the next media segment of the selected content.

The requested media segment may not, however, be available at content delivery platform 121 for download by user device 110. For example, delays involved in originally communicating the content to server 120, segmenting the content, encoding the content segments, etc., particularly in a live streaming situation, may result in a media segment not being available to streaming content logic 113 at the availability time designated by the content identifier. For example, content delivery platform 121 may provide a response that the media segment is unavailable, as illustrated by response 304, issued in response to request 303, shown in FIG. 3A. If it is determined that the requested media segment has not been received by user device 110 at block 204, processing may proceed to block 207 to implement media segment request retry control.

At block 207, streaming content logic 113 may operates to determine a media segment retry back off interval providing a time interval between successive retries for a media segment (e.g., media segment retry back off interval 311 of FIG. 3A). The media segment retry back off interval may be determined as a function of attributes of media segments play-out buffer 115. Accordingly, in calculating the media segment retry back off interval, streaming content logic 113 may provide for an increased retry back off interval based on an increase in media segments play-out buffer size and/or a decrease in media segments play-out buffer depletion rate. Similarly, in calculating the media segment retry back off interval, streaming content logic 113 may provide for a decreased retry back off interval based on a decrease in media segments play-out buffer size and/or increase in media segments play-out buffer depletion rate.

As discussed in detail above, embodiments may implement uniform or non-uniform retry back off intervals. That is, a plurality of media segment retry back off intervals utilized with respect to a particular media segment may be the same or may be different (e.g., media segment retry back off intervals 331 and 332 of FIG. 3B may be either the same or different, depending upon the embodiment implemented). Accordingly, different retry back off intervals may be calculated not only with respect to different streaming content sessions, different media segments, etc., but also for different retries with respect to a particular media segment. For example, depending upon where the retry falls within a media segment availability window (e.g., first portion, second portion, etc.), the retry back off period may be determined differently, such as to implement a shorter retry back off interval and thus more retries within one portion of the media segment availability window and to implement a longer retry back off interval and thus fewer retries within another portion of the media segment availability window.

Embodiments of streaming content logic 113 implement a media segment retry termination point in order to limit the retry attempts to those likely to satisfactorily obtain the media segment (e.g., avoid obtaining a media segment where playback would be delayed to the point of not being acceptable as “real-time” to the user, where a next media segment is available, etc.). For example, streaming content logic 113 may operate to retry for any particular media segment until the earlier of a media segment availability event (e.g., the receipt of the previously unavailable media segment or the availability of a next media segment) and/or a media segment retry termination point (e.g., the cutoff point beyond which the client does not attempt another retry). Accordingly, streaming content logic 113 may further operate to calculate a media segment retry termination point (e.g., before, during, or after block 207) establishing a point at which further retries for a media segment will not be attempted (e.g., media segment retry termination point 341 of FIG. 3B). As discussed in detail above, such a media segment retry termination point utilized according to embodiments may be based upon an estimated transaction time for the media segment download (e.g., media segment retry termination point 341 may be determined to be a point in time, greater than or equal to the “transaction time”, before scheduled next media segment availability time 342 as shown in FIG. 3B). Calculation of a media segment retry termination point may thus include or otherwise utilize transaction time determination, averaging, smoothing, etc.

Although calculation of media segment retry back off intervals and media segment retry termination points are discussed above as being performed at block 207 within a retry loop of flow 200, it should be appreciated that embodiments may operate to perform such calculations outside of such a retry loop. For example, an embodiment may operate to calculate one or more retry back off intervals and/or media segment retry termination points less frequently, such as one time for a streaming media session, or with predetermined periodicity (e.g., once per minute or some statistically relevant epoch). Embodiments of a media segment retry control system, however, perform either or both of the foregoing calculations frequently, such as to dynamically determine retry back off intervals responsive to a current state or trend of the media segment buffer, to dynamically determine media segment retry termination points responsive to a current state or trend of the transaction times, etc.

At block 208 wherein a determination is made as to whether the present time, which is just before a retry request may be made, is beyond the media segment retry termination point. That is, if the media segment retry termination point has been reached, and thus no further retries are to be made with respect to the media segment that had not been received, then processing according to embodiments branches so as to avoid a further retry for the media segment. For example, if it is determined that the present time is beyond (e.g., equal to or greater than) the media segment retry termination point, operation according to the illustrated embodiment returns to block 203 wherein the next media segment of the streaming content is requested. However, if it is determined that the present time is not beyond the media segment retry termination point, the user device may initiate a retry at block 209. For example, streaming content logic 113 may again request the media segment which was previously unavailable.

Having retried for the media segment, flow 200 may return to block 204 for a determination as to whether the media segment has been received. Thus, the illustrated flow provides a loop in which retries may be initiated for the media segment until such time as the media segment is received or a media segment retry termination point is reached. Such repeated retries are illustrated in FIG. 3B by request 321 and corresponding response 322 indicating the media segment is unavailable, media segment retry back off interval 331 implemented before retry request 323 and corresponding response 324 indicating the media segment is still unavailable, and media segment retry back off interval 332 implemented before retry request 325. Although such retry attempts may result in receipt of the media segment, to facilitate an understanding of the concepts herein the ladder diagram illustrated in FIG. 3B shows response 326 indicating the media segment remains unavailable just prior to media segment retry termination point 341 which establishes the time beyond which no further retries for the media segment are to be attempted according to embodiments. It should be appreciated that the media segment retry control provided in accordance with the foregoing efficiently and effectively attempts to obtain media segments through implementation of the retry back off intervals as described herein. Moreover, implementation of the media segment retry termination point, which is based upon the next segment availability time and the transaction time, facilitates maintaining real-time or near real-time (e.g., as perceived by the user) streaming content while providing for efficient use of the bandwidth and minimizing degradation of the user experience.

Although selected aspects have been illustrated and described in detail, it will be understood that various substitutions and alterations may be made therein without departing from the spirit and scope of the present invention, as defined by the following claims.

What is claimed is:

1. A method of media content communication comprising:
determining that a media segment is not available from a streaming media server; and
calculating a media segment retry back off interval as a function of an aspect of a client media segments play-out buffer, wherein the media segment retry back off interval defines a period before the client retries requesting the media segment from the streaming media server.

2. The method of claim 1, wherein the media segment comprises a media segment of live adaptive streaming media content.

3. The method of claim 1, wherein the aspect of the client media segments play-out buffer comprises a depletion rate of content from the client media segments play-out buffer.

4. The method of claim 1, wherein the aspect of the client media segments play-out buffer comprises a change in size of the client media segments play-out buffer.

5. The method of claim 1, further comprising:
utilizing the retry back off interval in a uniform retry pattern adapted to initiate retrying the media segment a plurality of times, each after the media segment retry back off interval.

6. The method of claim 1, further comprising:
utilizing the retry back off interval in a non-uniform retry pattern adapted to initiate retrying the media segment a plurality of times, wherein at least one retry of the plurality uses a second retry back off interval different than the media segment retry back off interval.

7. The method of claim 6, wherein the second retry back off interval comprises a second media segment retry back off interval dynamically calculated as a function of the aspect of a client media segments play-out buffer.

8. The method of claim 1, further comprising:
calculating an estimated transaction time for media segment download to the client, wherein the estimated transaction time comprises a round trip time for requesting a media segment through completion of download of the requested media segment to the client;
establishing a media segment retry termination point as a function of the estimated transaction time and a next media segment availability time; and
retrying the media segment after the retry back off interval if a time for the retry is not beyond the media segment retry termination point.

9. A computer program product for wireless communications in a wireless network, comprising:
a computer-readable medium having program code recorded thereon, said program code comprising:
program code to determine that a media segment is not available from a streaming media server; and
program code to calculate a media segment retry back off interval as a function of an aspect of a client media segments play-out buffer, wherein the media segment retry back off interval defines a period before the client retries requesting the media segment from the streaming media server.

10. The computer program product of claim 9, wherein the aspect of the client media segments play-out buffer comprises a depletion rate of content from the client media segments play-out buffer.

11. The computer program product of claim 9, wherein the aspect of the client media segments play-out buffer comprises a change in size of the client media segments play-out buffer.

12. The computer program product of claim 9, wherein the program code further comprises:
program code to calculate an estimated transaction time for media segment download to the client, wherein the estimated transaction time comprises a round trip time for requesting a media segment through completion of download of the requested media segment to the client;
program code to establish a media segment retry termination point as a function of the estimated transaction time and a next media segment availability time; and
program code to retry the media segment after the retry back off interval if a time for the retrying is not beyond the media segment retry termination point.

13. An apparatus configured for wireless communication, said apparatus comprising
at least one processor; and
a memory coupled to said at least one processor,
wherein said at least one processor is configured:
to determine that a media segment is not available from a streaming media server; and
to calculate a media segment retry back off interval as a function of an aspect of a client media segments play-out buffer, wherein the media segment retry back off interval defines a period before the client retries requesting the media segment from the streaming media server.

14. The apparatus of claim 13, wherein the media segment comprises a media segment of live adaptive streaming media content.

15. The apparatus of claim 13, wherein the aspect of the client media segments play-out buffer comprises a depletion rate of content from the client media segments play-out buffer.

16. The apparatus of claim 13, wherein the aspect of the client media segments play-out buffer comprises a change in size of the client media segments play-out buffer.

17. The apparatus of claim 13, wherein the at least one processor is further configured:
to utilize the retry back off interval in a uniform retry pattern adapted to initiate retrying the media segment a plurality of times, each after the media segment retry back off interval.

18. The apparatus of claim 13, wherein the at least one processor is further configured:
to utilize the retry back off interval in a non-uniform retry pattern adapted to initiate retrying the media segment a plurality of times, wherein at least one retrying of the plurality uses a second retry back off interval different than the media segment retry back off interval.

19. The apparatus of claim 18, wherein the second retry back off interval comprises a second media segment retry back off interval dynamically calculated as a function of the aspect of a client media segments play-out buffer.

20. The apparatus of claim 13, wherein the at least one processor is further configured:
to calculate an estimated transaction time for media segment download to the client, wherein the estimated transaction time comprises a round trip time for requesting a media segment through completion of download of the requested media segment to the client;
to establish a media segment retry termination point as a function of the estimated transaction time and a next media segment availability time; and
to retry the media segment after the retry back off interval if a time for the retry is not beyond the media segment retry termination point.
